(19) United States
(12) Patent Application Publication
(10) Pub. No.: US 2013/0185017 A1
(43) Pub. Date: Jul. 18, 2013

(54) Method for Supervising the Correct Function of a Periodically Modulated Sensor Controlling the Position of a Rotating System and Controller Device for Performing this Method

(71) Applicant: SICK STEGMANN GmbH, Donaueschingen (DE)

(72) Inventor: Massimo FRANCESCON, Torino (IT)

(73) Assignee: SICK STEGMANN GmbH, Donaueschingen (DE)

(21) Appl. No.: 13/733,918

(22) Filed: Jan. 4, 2013

(30) Foreign Application Priority Data
Jan. 13, 2012 (EP) 12151124.0

(51) Int. Cl. G01B 7/00; G06F 17/16

(52) U.S. Cl. CPC G01B 7/003; G06F 17/16
USPC 702/150

(57) ABSTRACT

A method for supervising the correct function of a periodically modulated sensor controlling the position of a rotating system, includes the steps of a) determining a response \vec{gᵢ}=(g_{ci},gₛᵢ) of the periodically modulated sensor, b) determining the inverse K=W⁻¹ of a 2×2 matrix W describing gains and rotations induced by a digital signal processing routine applied to the raw sensor data to extract the position data, c) determining the complex number m=m_{cos}+imₛᵢₙ obtained by processing a raw sensor data value aᵢ corresponding to a first position of the rotating system with the digital signal processing routine, d) calculating an estimate a′ᵢ for the next raw sensor data value aᵢ₊₁ based on the formula a′ᵢ=gᵢK\vec{m}, where

$$\vec{m} = ( \begin{matrix}{m}_{cos} \\ {m}_{sin}\end{matrix} ) ,$$

and e) comparing the estimate and the next raw sensor data and creating an alert if the result of this comparison exceeds a predetermined value.

Periodically modulated sensors, especially periodically modulated capacitive sensors, controlling the position of a rotating system are known e.g. from EP 1 538 422 B1. They are usually based on two differential excitation signals that provide the periodic modulations in quadrature which are combined by the sensor depending on the angle to be measured to a sensor signal. Usually, the signal is amplified and converted into the digital domain, leading to a time discrete signal aᵢ. By application of digital algorithms involving bandpass filtering and performing a discrete Fourier transform on a series of thus obtained time discrete signals is converted to a complex number m, whose phase corresponds to the angular position of the rotating system that is the aim of the measurement, whereas the amplitude depends on other physical parameters of the system and is essentially constant unless axial displacement of the sensor rotor occurs. In practice, m is represented by its components along two orthogonal axes that essentially correspond to the cosine and the sine of the angle to be measured in an ideal case.

In general, whenever a sensor is used in a safety-related application, it is of crucial importance to supervise the correct function of the sensor. Ideally, it should be possible to check correctness and functionality of the sensor on-line. In the state of the art, this is achieved by adding diagnostic features to a sensor, i.e. means that supervise the functionality of the respective sensor components.

However, the addition of such diagnostic features is expensive and cumbersome. Accordingly, the problem addressed by this invention is providing a method for controlling the correct function of a capacitive sensor supervising the position of a rotating system that does not require additional diagnostic features.

This problem is solved by am method with the features of claim 1 and a controller device for performing this method with the features of claim 6. Advantageous embodiments of the method and the device are obtained by the features of the respective dependent claims.

The method for supervising the correct function of a periodically modulated sensor controlling the position of a rotating system according to the invention comprises the steps of

a) determining a response \vec{g}ᵢ=(g_{ci}, gₛᵢ) of the periodically modulated sensor,
b) determining the inverse K=W⁻¹ of a 2×2 matrix W describing gains and rotations induced by a digital signal processing routine applied to the raw sensor data to extract the position data,
c) determining the complex number m=m_{cos}+imₛᵢₙ obtained by processing a raw sensor data value aᵢ corresponding to a first position of the rotating system with the digital signal processing routine,
d) calculating an estimate a′ᵢ for the next raw sensor data value aᵢ₊₁ based on the formula

$${a}_{i}^{′} = {g}_{i} K \vec{m} \\ where \\ \vec{m} = ( \begin{matrix}{m}_{cos} \\ {m}_{sin}\end{matrix} ) , \qquad ( 1 )$$

and
e) comparing the estimate and the next raw sensor data value and creating an alert if the result of this comparison exceeds a predetermined value.

A key feature of periodically modulated sensors controlling the position of a rotating system in general and especially of periodically modulated capacitive sensors is that they are typically driven with periodic modulation functions that have a significantly higher frequency than the frequency of the rotating system and with as small a signal lag as possible. As a consequence, the position data (i.e. usually the angular position of or phase information on the rotating system) are updated at points of time, between which the controlled position of the rotating system has changed only by a small amount and, accordingly, the output obtained from the sensor is not expected to be subject to drastic changes, but changing only slowly.

The key concept of the invention is based on the insight that as a consequence of this behavior, it should be possible to construct a black box model of the sensor and use data obtained as result of the preceding sensor data and their subsequent processing as input for the black box model so that the model provides an expected result obtained from the next sensor data. If the sensor continues to work as designed, this expected result obtained from the black box model based on the processed result of the last measurement should be a good approximation of the measured result of the next measurement, because of the expected slow change of the output obtained from subsequent measurements. A big deviation between expected result and processed result, which is readily determined by comparing these results, is indicative of a sensor failure and can be used to trigger a security alert. The threshold for acceptable deviations is dependent on the properties of the rotating system to be controlled using the sensor and the frequency of the periodic modulation functions driving the sensor that essentially determine the update rate for measured sensor data.

The black box model is constructed during steps a) and b) of the method, which usually need to be performed only once unless the rotating system or sensor operating conditions (e.g. the periodic modulation functions used) are changed. The construction of the black box model is discussed in more detail below. Once the black box model has been constructed and a first measured sensor data value is available, steps c), d) and e) may be repeated for each further measured sensor data value.

In a preferred embodiment of the invention, the 2×2 matrix K is determined by determination of a set of numbers k₁₁, k₁₂, k₂₁, k₂₂ so that the combination of k₁₁g_{ci} and k₂₁gₛᵢ called hₛᵢ leads to

$$\vec{m} = ( \begin{matrix}1 \\ 0\end{matrix} )$$

and that the combination of k₂₁g_{ci} and k₂₂gₛᵢ called hₛᵢ leads to

$${m}^{} = ( \begin{matrix}0 \\ 1\end{matrix} )$$

and setting

$$K = ( \begin{matrix}{k}_{11} & {k}_{12} \\ {k}_{21} & {k}_{22}\end{matrix} ) ,$$

so that

$$\begin{matrix}{{h}_{ι}}^{} = ( {h}_{ci} , {h}_{si} ) \\ = {{g}_{ι}}^{} K \\ = {{g}_{ι}}^{} ( \begin{matrix}{k}_{11} & {k}_{12} \\ {k}_{21} & {k}_{22}\end{matrix} ) \\ = ( {g}_{c i} {k}_{11} + {g}_{si} {k}_{21} , {g}_{ci} {k}_{12} + {g}_{si} {k}_{22} ) .\end{matrix} \qquad ( 2 )$$

In other words, after the determination of the response \vec{g}ᵢ=(g_{ci},gₛᵢ) of the sensor, which may e.g. be done by measurement when just one excitation signal is driven, the coordinate system in which the estimate a′ᵢ is calculated is changed in such a way that the calculation of the estimate requires a smaller number of operations at runtime, as a′ᵢ=\vec{gᵢ}K\vec{m}=\vec{hᵢ}\vec{m}. This is important, because the high rate of measurements to be processed requires that the estimate is known as quickly as possible.

In another preferred embodiment of the method that also contributes to the possibility to provide the estimate as quickly as possible, raw output of the discrete Fourier transform is used as input data for step d). However, it turns out that this can cause a small systematic error proportional to the rotation speed for the calculated estimate, because the thus obtained sine and cosine signals contain demodulation terms with double frequency of the frequency of the periodic modulation function used for excitation of the sensor. The estimator essentially performs a further modulation operation, which reflects these terms back into the base band. Therefore, it is advantageous to filter either the input data for the estimator or the output data of the estimator.

The ideal way to filter is a notch filter that is applied to both the sine and the cosine input data. A much cheaper possibility that leads to good results is using a high pass filter on the output. The threshold frequency for the high pass filter should be chosen to be lower than the frequency of the periodic modulation function.

The controller device according to the invention comprises a periodically modulated sensor, a signal generator for providing periodic excitation functions for the periodically modulated sensor and a data processing device for performing a discrete Fourier transform on data provided by the sensor and for filtering of data provided by the sensor.

Furthermore, according to the invention the controller device further also comprises an estimator device for calculating an estimate a′ᵢ for the next raw sensor data value aᵢ₊₁ based on the formula a′ᵢ=gᵢK\vec{m}, where

$${m}^{} = ( \begin{matrix}{m}_{cos} \\ {m}_{sin}\end{matrix} )$$

is the vector representation of complex number m=m_{cos}+imₛᵢₙ obtained by processing a raw sensor data value aᵢ corresponding to a first position of the rotating system with the digital signal processing routine, \vec{gᵢ}=(g_{ci},gₛᵢ) represents a response of the sensor and K=W⁻¹ is the inverse of a 2×2 matrix W describing gains and rotations induced by a digital signal processing routine applied to the raw sensor data to extract the position data.

In a preferred embodiment of the controller device that leads to more reliable data, the controller device comprises amplification means for amplifying the raw output data of the sensor output.

In another preferred embodiment, the controller device comprises A/D conversion means for providing digitalized input data to the data processing device.

In general, the data processing device and/or the estimator device may be realized by hardware-based circuitry or, alternatively, be realized by software executed by a CPU. A software-based realization both the data processing device and the estimator device is attractive because it allows for the cheap addition of the estimator relying essentially on hardware that is already present.

The reliability of the estimate used by the controller device to supervise the proper function of the sensor can be increased if the controller device comprises filtering means for filtering the input data provided to the estimator device and/or for filtering the output data of the estimator.

Next, the invention is explained in more detail using a FIGURE showing a block diagram of a periodically modulated sensor system according to an embodiment of the invention. The FIGURE shows

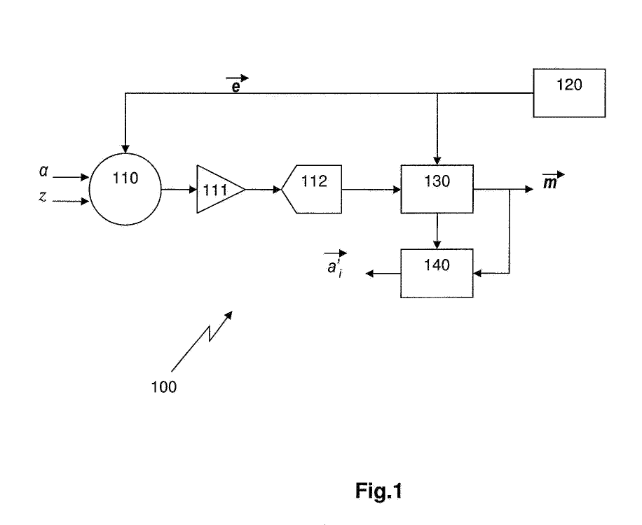

FIG. 1: a controller device for supervising the correct function of a periodically modulated capacitive sensor controlling the position of a rotating system by the method according to the invention.

The controller device 100 shown in FIG. 1 comprises a periodically modulated sensor 110 realized as a periodically modulated capacitive sensor, a signal generator 120 for providing periodic excitation functions for the periodically modulated sensor 110, a data processing device 130 for performing a discrete Fourier transform on data provided by the sensor and for filtering of data provided by the sensor and an estimator device 140 for calculating an estimate a′ᵢ for the next raw sensor data value aᵢ₊₁. Furthermore, the controller device 100 comprises amplification means 111 for amplifying the raw output data of the sensor that can be realized e.g. as amplifier and A/D conversion means 112 that may be realized as A/D converter providing digitalized input data to the data processing device 130.

FIG. 1 can also be used to explain the black box model that is created according to the invention in more detail. As indicated in FIG. 1, three variables are relevant for the value that is measured by the periodically modulated sensor 110, especially if the periodically modulated sensor 110 is a capacitive rotation sensor: the current position α (specifically angle or phase) of the rotating system, the axial displacement z of the rotor of the periodically modulated sensor 110, and the periodic modulation function that is used as excitation \vec{e}. As the modulation function is periodic and time discrete—preferably created by combination of four time discrete periodic signals with period P that are shifted relative to each other by P/4−, it may be described in terms of a complex-valued function

$${e}^{->} = ( \begin{matrix}{e}_{ci} \\ {e}_{si}\end{matrix} ) .$$

Accordingly, the complex output value aᵢ of the periodically modulated sensor 110 for a given data sampling i can be written as aᵢ=S(α,z,\vec{e}), where S is the sensor function describing the dependence of the output of the periodically modulated sensor 110 on the three variables mentioned above.

In order to arrive at the result

$${m}^{} = ( \begin{matrix}{m}_{cos} \\ {m}_{sin}\end{matrix} )$$

that is used for the extraction of the desired position data, specifically angle or phase, from the raw sensor data represented by aᵢ, filtering and an operation of discrete Fourier transform type, whose roots are advantageously also provided by the signal generator 120, are performed. These actions may be summarized in terms of a digital algorithm function D acting on aᵢ. Accordingly,

$${m}^{} = ( \begin{matrix}{m}_{cos} \\ {m}_{sin}\end{matrix} ) = D ( {a}_{i} ) = D ( S ( α , z , {e}^{->} ) ) \qquad ( 3 )$$

A periodically modulated sensor 110, specifically if it is a capacitive rotation sensor, acts mainly as a modulator. This means that the sensor function S(α,z,\vec{e}) can be defined more precisely, leading to the relation

aᵢ=S(α,z,\vec{e}))=F(z)(g_{ci} cos α+gₛᵢ sin α)=(g_{ci}A_{c}+gₛᵢAₛ)=\vec{gᵢ}\vec{A} (4),

where \vec{gᵢ}=(g_{ci},gₛᵢ) represents the response of the physical system to the excitation, which can be measured when just one excitation signal is driven. Because linearity and time invariance are given, these functions are also periodical and shifted by one quarter of a period.

Next, the effects of the digital algorithm function are analyzed. The discrete Fourier transform is a linear and time-invariant operation that leads to a demodulation of the signal it is applied to in two orthogonal components. Analog and digital filtering may lead to gains and phase rotations. The generical form to describe these operations is a matrix W, which yields:

$${m}^{} = ( \begin{matrix}{m}_{cos} \\ {m}_{sin}\end{matrix} ) = W ( \begin{matrix}{A}_{c} \\ {A}_{s}\end{matrix} ) = W {A}^{->} . \qquad ( 5 )$$

Once the matrix W is determined, its inverse K=W⁻¹ can be determined and applied to equation 5 from the left hand side, leading to

$$K {m}^{} = {W}^{- 1} W ( \begin{matrix}{A}_{c} \\ {A}_{s}\end{matrix} ) = {A}^{->} .$$

As mentioned above, \vec{gᵢ}=(g_{ci},gₛᵢ) can be measured when just one excitation signal is driven and thus can be calculated using formula (4) if the periodically modulated sensor 110 is read at a sufficiently high frequency to justify the assumption that \vec{m} does change significantly between two readings of the sensor output value.

### REFERENCE NUMERALS

100 controller device
110 periodically modulated sensor
111 amplification means
112 A/D conversion means
120 internal signal generator
130 data processing circuit
140 estimator device

1. Method for supervising the correct function of a periodically modulated sensor (110) controlling the position of a rotating system, said method comprising the steps of
a) determining a response \vec{gᵢ}=(g_{ci},gₛᵢ) of the periodically modulated sensor (110),
b) determining the inverse K=W⁻¹ of a 2×2 matrix W describing gains and rotations induced by a digital signal processing routine applied to the raw sensor data to extract the position data,
c) determining the complex number m=m_{cos}+imₛᵢₙ obtained by processing a raw sensor data value aᵢ corresponding to a first position of the rotating system with the digital signal processing routine,
d) calculating an estimate a′ᵢ for the next raw sensor data value aᵢ₊₁ based on the formula a′ᵢ=gᵢK\vec{m}, where
$${m}^{} = ( \begin{matrix}{m}_{cos} \\ {m}_{sin}\end{matrix} ) ,$$
and
e) comparing the estimate and the next raw sensor data and creating an alert if the result of this comparison exceeds a predetermined value.

2. Method according to claim 1, characterized in that the 2×2 matrix K is determined by determination of a set of numbers k₁₁,k₁₂, k₂₁,k₂₂ so that the combination of k₁₁g_{ci} and k₂₁gₛᵢ called h_{ci} leads to
$${m}^{} = ( \begin{matrix}1 \\ 0\end{matrix} )$$
and that the combination of k₂₁g_{ci} and k₂₂gₛᵢ called hₛᵢ leads to
$${m}^{} = ( \begin{matrix}0 \\ 1\end{matrix} )$$
and setting
$$K = ( \begin{matrix}{k}_{11} & {k}_{12} \\ {k}_{21} & {k}_{22}\end{matrix} ) ,$$
so that
$$\begin{matrix}{{h}_{ι}}^{} = ( {h}_{ci} , {h}_{si} ) \\ = {{g}_{ι}}^{} K \\ = {{g}_{1}}^{} ( \begin{matrix}{k}_{11} & {k}_{12} \\ {k}_{21} & {k}_{22}\end{matrix} ) \\ = ( {g}_{ci} {k}_{11} + {g}_{si} {k}_{21} , {g}_{ci} {k}_{12} + {g}_{si} {k}_{22} )\end{matrix}$$

3. Method according to claim 1, characterized in that the raw output of the discrete Fourier transform is used as input data for step d).

4. Method according to claim 3, characterized in that the input data for step d) are filtered using a notch filter.

5. Method according to claim 3, characterized in that the calculated estimate is filtered using a high pass filter.

6. Controller device (100) for performing the method according to claim 1, said controller device (100) comprising a periodically modulated sensor (110), a signal generator (120) for providing periodic excitation functions for the periodically modulated sensor (110) and a data processing device (130) for performing a discrete Fourier transform on data provided by the sensor and for filtering of data provided by the periodically modulated sensor (110), characterized in that the controller device (100) further comprises an estimator device (140) for calculating an estimate a′ᵢ for the next raw sensor data value aᵢ₊₁ based on the formula a′ᵢ=gᵢK\vec{m}, wherein
$${m}^{} = ( \begin{matrix}{m}_{cos} \\ {m}_{sin}\end{matrix} )$$
is the vector representation of complex number m=m_{cos}+imₛᵢₙ obtained by processing a raw sensor data value aᵢ corresponding to a first position of the rotating system with the digital signal processing routine, \vec{gᵢ}=(g_{ci},gₛᵢ) represents a response of the sensor and K=W⁻¹ is the inverse of a 2×2 matrix W describing gains and rotations induced by a digital signal processing routine applied to the raw sensor data to extract the position data.

7. Controller device (100) according to claim 6, characterized in that the controller device (100) comprises amplification means (111) for amplifying the raw output data obtainable from the periodically modulated sensor (110).

8. Controller (100) device according to claim 6, characterized in that the controller device (100) comprises A/D conversion means (112) for providing digitalized input data to the data processing device.

9. Controller device (100) according to claim 6, characterized in that the controller device (100) comprises filtering means for filtering the input data provided to the estimator device (140) and/or for filtering the output data of the estimator device (140).
